(19) United States
(12) Patent Application Publication
(10) Pub. No.: US 2018/0104652 A1
(43) Pub. Date: Apr. 19, 2018

(54) REVERSE OSMOSIS MEMBRANE CLEANING METHOD AND REVERSE OSMOSIS MEMBRANE CLEANING APPARATUS

(71) Applicant: MITSUBISHI HEAVY INDUSTRIES, LTD., Tokyo (JP)

(72) Inventors: Yoshiaki Ito, Tokyo (JP); Hidemasa Kakigami, Tokyo (JP); Katsuhiko Yokohama, Tokyo (JP); Masayuki Tabata, Tokyo (JP); Shintaro Taura, Tokyo (JP); Takayoshi Hori, Tokyo (JP); Katsunori Matsui, Tokyo (JP); Masanori Kawada, Tokyo (JP)

(73) Assignee: MITSUBISHI HEAVY INDUSTRIES, LTD., Tokyo (JP)

(21) Appl. No.: 15/567,243

(22) PCT Filed: Apr. 18, 2016
(86) PCT No.: PCT/JP2016/062280

§ 371 Date: Oct. 17, 2017

(30) Foreign Application Priority Data
Apr. 21, 2015 (JP) 2015-086714

(51) Int. Cl. B01D 65/02; B01D 61/10; B01D 61/02; B01D 71/10; B01D 71/56

(52) U.S. Cl. CPC B01D 65/02; B01D 61/10; B01D 61/025; B01D 2321/162; B01D 71/56; B01D 2321/08; B01D 71/10

(57) ABSTRACT

Provided is a reverse osmosis membrane cleaning apparatus (10) which includes a membrane module (1) including a reverse osmosis membrane, a cleaning water tank (11) which stores cleaning water, a heater (13) which heats cleaning water supplied from the cleaning water tank (11) to the reverse osmosis membrane, and a temperature control device (17) which controls the heater so that a temperature of the cleaning water heated by the heater (13) is higher than 45° C. and not higher than 60° C.

### TECHNICAL FIELD

The present invention relates to a reverse osmosis membrane cleaning method and a reverse osmosis membrane cleaning apparatus.

Priority is claimed on Japanese Patent Application No. 2015-086714, filed Apr. 21, 2015, the content of which is incorporated herein by reference.

### BACKGROUND ART

In a seawater desalination apparatus including a reverse osmosis membrane, seawater to be treated is first passed through a pretreatment device filled with a hollow fiber membrane or the like to remove impurities such as solids. The seawater treated in the pretreatment device is pressurized by a high pressure pump and brought into contact with the reverse osmosis membrane, and then is separated into fresh water passing through the reverse osmosis membrane and concentrated seawater not passing through the reverse osmosis membrane. The obtained fresh water is used for applications such as drinking water.

As a factor of causing a decrease in permeation performance through the reverse osmosis membrane, clogging due to adhesion of scale including metal compounds such as iron and manganese and organic matter including microorganisms and metabolites thereof contained in seawater is exemplified. For the purpose of cleaning such clogging, a chemical cleaning line is generally installed in a seawater desalination apparatus in which a reverse osmosis membrane is included. When an amount of treated water of a reverse osmosis membrane or a hollow fiber membrane decreases, the operation is stopped and chemical cleaning using chemicals is performed.

As a method of removing scale adhered to a water treatment membrane such as a reverse osmosis membrane and a hollow fiber membrane, a method of cleaning with a cleaning liquid containing chemicals such as hypochlorous acid, citric acid, hydrogen peroxide or the like is known. For example, a method of cleaning a membrane module using a cleaning liquid containing 50 to 1.500 mg/liter of citric acid and adjusted to the pH of 1.0 to 3.0 is disclosed in Patent Literature 1.

### CITATION LIST

### Patent Literature

### [Patent Literature 1]

Japanese Unexamined Patent Application, First Publication No. H11-9973

### SUMMARY OF INVENTION

### Technical Problem

Due to abnormal weather associated with global warming in recent years, a seawater temperature with seasonal variation tends to rise more than usual. There are cases in which organic scale adhered to a reverse osmosis membrane provided in a seawater desalination plant increases abnormally due to a rise in seawater temperature, fouling progresses to such an extent that cannot be coped with a conventional cleaning method, and a situation in which it is inevitable to stop the operation of the plant occurs.

The present invention has been made to solve the problems described above and provides a reverse osmosis membrane cleaning method and a reverse osmosis membrane cleaning apparatus capable of improving a cleaning effect with an increase in water permeability coefficient as an index while suppressing membrane degradation with a rate of increase in salt permeability coefficient as an index.

### Solution to Problem

In order to solve the problems described above, the present invention provides the following aspects.

A first aspect of the present invention is a reverse osmosis membrane cleaning method of cleaning a reverse osmosis membrane with cleaning water having a temperature higher than 45° C. and not higher than 60° C.

According to the reverse osmosis membrane cleaning method of the first aspect, since the use temperature of the cleaning water is higher than 45° C. and higher than that of conventional cleaning water, detergency with respect to stripping or eluting scale from the reverse osmosis membrane is high. In addition, since the cleaning water has a temperature of 60° C. or lower, degradation of the reverse osmosis membrane due to heat can be suppressed while enhancing a cleaning effect.

A second aspect of the present invention is the reverse osmosis membrane cleaning method according to the first aspect, wherein the cleaning water may be circulated through the reverse osmosis membrane while passing through a filter.

According to the reverse osmosis membrane cleaning method of the second aspect, since dust and scale dissolved in the circulating cleaning water can be removed by the filter, the cleaning water can be reused and the cost required for a process of disposing the cleaning water can be reduced.

A third aspect of the present invention is the reverse osmosis membrane cleaning method according to the first or second aspect, wherein an organic acid may be contained in the cleaning water.

According to the reverse osmosis membrane cleaning method of the third aspect, it is possible to enhance the cleaning effect while suppressing degradation of the reverse osmosis membrane even in a high temperature range higher than 45° C. and not higher than 60° C.

A fourth aspect of the present invention is the reverse osmosis membrane cleaning method according to the third aspect, wherein citric acid and a citrate as the organic acid may be contained in a range of 2.0 to 22 g/L as a citric acid concentration.

According to the reverse osmosis membrane cleaning method of the fourth aspect, it is possible to enhance the cleaning effect while suppressing degradation of the reverse osmosis membrane even in a high temperature range higher than 45° C. and not higher than 60° C.

A fifth aspect of the present invention is the reverse osmosis membrane cleaning method according to any one of the first to fourth aspects, wherein the pH of the cleaning water may be adjusted to a range of 3.5 to 5.5.

According to the reverse osmosis membrane cleaning method of the fifth aspect, it is possible to enhance the cleaning effect while suppressing degradation of the reverse osmosis membrane even in a high temperature range higher than 45° C. and not higher than 60° C.

A sixth aspect of the present invention is the reverse osmosis membrane cleaning method according to any one of the first to fifth aspects, wherein a cleaning time in which the cleaning water and the reverse osmosis membrane are in contact may be 12 hours or less.

According to the reverse osmosis membrane cleaning method of the sixth aspect, it is possible to enhance the cleaning effect while suppressing degradation of the reverse osmosis membrane even in a high temperature range higher than 45° C. and not higher than 60° C.

A seventh aspect of the present invention is the reverse osmosis membrane cleaning method according to any one of the first to sixth aspects, wherein the reverse osmosis membrane may be formed of a cellulose-based polymer or a polyamide-based polymer.

According to the reverse osmosis membrane cleaning method of the seventh aspect, it is possible to enhance the cleaning effect while suppressing degradation of the reverse osmosis membrane even in a high temperature range higher than 45° C. and not higher than 60° C.

An eighth aspect of the present invention is a reverse osmosis membrane cleaning apparatus which includes a membrane module having a reverse osmosis membrane, a cleaning water tank that stores cleaning water, a heater which heats cleaning water supplied from the cleaning water tank to the reverse osmosis membrane, and a temperature control device that controls the heater so that a temperature of the cleaning water heated by the heater is higher than 45° C. and not higher than 60° C.

According to the reverse osmosis membrane cleaning apparatus of the eighth aspect, since a temperature control device is provided, it is possible to stably supply cleaning water at a predetermined temperature to clean the reverse osmosis membrane.

A ninth aspect of the present invention is the reverse osmosis membrane cleaning apparatus according to the eighth aspect, wherein the temperature control device may control the heater so that a temperature of the cleaning water heated by the heater is higher than 45° C. and not higher than 55° C.

According to the reverse osmosis membrane cleaning apparatus of the ninth aspect, since a temperature control device is provided, it is possible to stably supply cleaning water at a predetermined temperature to clean the reverse osmosis membrane.

A tenth aspect of the present invention is the reverse osmosis membrane cleaning apparatus according to the eighth or ninth aspect, wherein a circulation pump which circulates the cleaning water between the membrane module and the cleaning water tank, and a filter through which the circulating cleaning water passes may be included.

According to the reverse osmosis membrane cleaning apparatus of the tenth aspect, since dust and scale dissolved in the circulating cleaning water can be removed by the filter, the cleaning water can be reused and the cost required for a process of disposing the cleaning water can be reduced.

An eleventh aspect of the present invention is the reverse osmosis membrane cleaning apparatus according to any one of the eighth to tenth aspects, wherein an organic acid may be contained in the cleaning water.

According to the reverse osmosis membrane cleaning apparatus of the eleventh aspect, it is possible to enhance the cleaning effect while suppressing degradation of the reverse osmosis membrane even in a high temperature range higher than 45° C. and not higher than 60° C.

A twelfth aspect of the present invention is the reverse osmosis membrane cleaning apparatus according to the eleventh aspect, wherein citric acid and a citrate as the organic acid may be contained in a range of 2.0 to 22 g/L as a citric acid concentration.

According to the reverse osmosis membrane cleaning apparatus of the twelfth aspect, it is possible to enhance the cleaning effect while suppressing degradation of the reverse osmosis membrane even in a high temperature range higher than 45° C. and not higher than 60° C.

A thirteenth aspect of the present invention is the reverse osmosis membrane cleaning apparatus according to any one of the eighth to twelfth aspects, wherein the pH of the cleaning water may be in a range of 3.5 to 5.5.

According to the reverse osmosis membrane cleaning apparatus of the thirteenth aspect, it is possible to enhance the cleaning effect while suppressing degradation of the reverse osmosis membrane even in a high temperature range higher than 45° C. and not higher than 60° C.

A fourteenth aspect of the present invention is the reverse osmosis membrane cleaning apparatus according to any one of the eighth to thirteenth aspects, wherein a pump control device which controls to stop driving of the circulation pump within 12 hours or less after driving the circulation pump may be included.

According to the reverse osmosis membrane cleaning apparatus of the fourteenth aspect, under the control of the pump control device, by stopping the circulation pump after driving of 12 hours or less to end the cleaning treatment, it is possible to prevent the reverse osmosis membrane from degrading due to inadvertent prolonged cleaning. Therefore, it is possible to enhance the cleaning effect while suppressing degradation of the reverse osmosis membrane even in a high temperature range higher than 45° C. and not higher than 60° C.

A fifteenth aspect of the present invention is the reverse osmosis membrane cleaning apparatus according to any one of the eighth to fourteenth aspects, wherein the reverse osmosis membrane may be formed of a cellulose-based polymer or a polyamide-based polymer.

According to the reverse osmosis membrane cleaning apparatus of the fifteenth aspect, it is possible to enhance the cleaning effect while suppressing degradation of the reverse osmosis membrane even in a high temperature range higher than 45° C. and not higher than 60° C.

### Advantageous Effects of the Invention

According to the reverse osmosis membrane cleaning method of the present invention, degradation of the membrane is suppressed and a cleaning effect can be enhanced.

According to the reverse osmosis membrane cleaning apparatus of the present invention, cleaning water maintained at a predetermined temperature can be supplied to the reverse osmosis membrane to obtain a high cleaning effect.

### BRIEF DESCRIPTION OF DRAWINGS

FIG. 1 is a schematic cross-sectional view of a reverse osmosis membrane module in which a reverse osmosis membrane is provided in a vessel.

FIG. 2 is a view illustrating a configuration of a reverse osmosis membrane cleaning apparatus connected to the reverse osmosis membrane module.

FIG. 3 is a bar graph illustrating a test result in which a temperature of cleaning water is changed in stages in Example 1.

FIG. 4 is a bar graph illustrating a test result in which cleaning time is changed in Example 2.

FIG. 5 is a bar graph illustrating a test result in which the pH of cleaning water is changed in stages in Example 3.

FIG. 6 is a bar graph illustrating a test result in which a concentration of citric acid contained in cleaning water is changed in stages in Example 4.

FIG. 7 is a bar graph illustrating a test result in which a temperature of cleaning water containing citric acid is changed in stages in Example 5.

### DESCRIPTION OF EMBODIMENTS

A cleaning method of the present invention is applicable to a known reverse osmosis membrane (RO membrane). Types and shapes of the RO membrane to which the cleaning method of the present invention can be applied are not particularly limited, and may include, for example, a flat disk-shaped membrane, a hollow fiber membrane, a spiral membrane, or a tubular membrane. The RO membrane preferably has at least two surfaces, a front surface and a back surface, that is, a primary surface (front surface) into which untreated water to be treated is introduced and a secondary surface (back surface) from which treated water that has passed through the RO membrane flows out. Types of untreated water to be treated by the RO membrane are not particularly limited, and seawater, river water, water supply and drainage, rain water, industrial wastewater, and the like are exemplified.

Since an RO membrane installed in a large-scale water treatment apparatus can be efficiently cleaned in an on-line state without being removed outside the apparatus, the cleaning method of the present invention is suitable, for example, for cleaning an RO membrane installed in a seawater desalination treatment plant.

A constituent material of the RO membrane to which the cleaning method of the present invention is applied is not particularly limited, and cellulose acetate, cellulose triacetate, cellulose nitrate, cellulose, polyamides, aromatic polyamides, polyolefins, polysulfone, polyacrylonitrile, polyester, polycarbonate, polyvinyl chloride, polyvinyl alcohol, polyvinylidene chloride, polyvinyl fluoride, polyvinylidene fluoride, hexafluoropropylene, chlorotrifluoroethylene, tetrafluoroethylene, silicone polymers, and the like are exemplified.

From a perspective of minimizing degradation of a membrane due to cleaning water of the present embodiment, the constituent material of the RO membrane is preferably a material selected from cellulose-based polymers such as cellulose acetate, cellulose triacetate, cellulose nitrate, and cellulose, and polyamide-based polymers such as polyamides and aromatic polyamides.

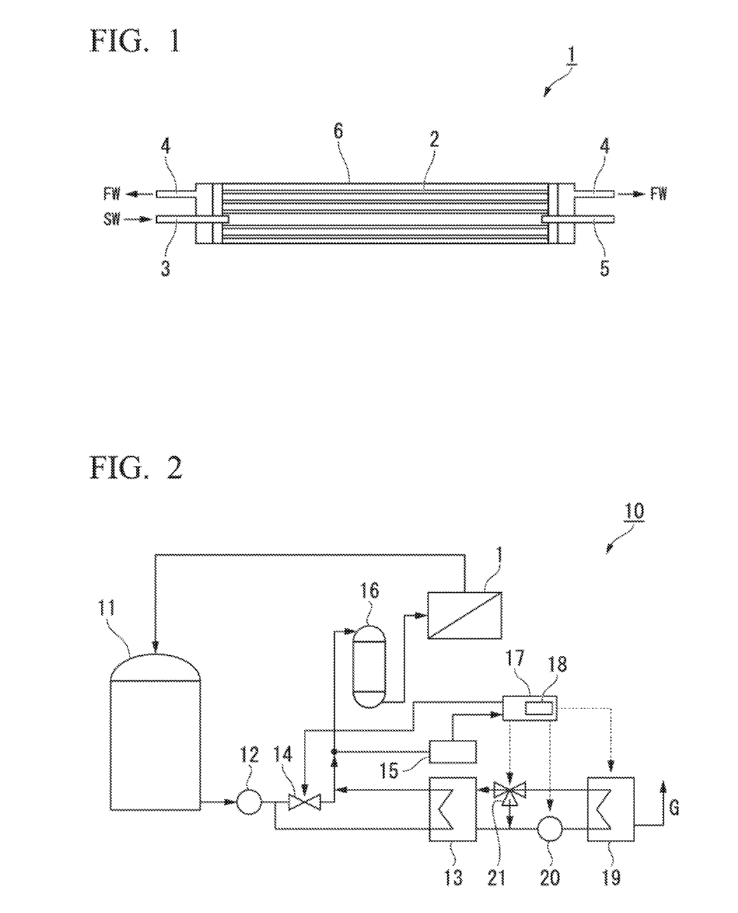

As a water treatment apparatus including an RO membrane to which the cleaning method of the present invention can be applied, an RO membrane module 1 illustrated in FIG. 1 is an example. In the RO membrane module 1, a plurality of hollow-fiber-shaped RO membranes 2 are folded back in a U shape, are resin-fixed in a state in which an open state of an end portion of each hollow fiber is maintained, and are contained in a vessel (pressure-resistant container) 6.

In typical seawater desalination treatment, seawater SW is supplied into a vessel 6 from a supply piping 3, and is brought into contact with a primary surface constituting an outer circumference of the hollow-fiber-shaped RO membranes 2 and permeates therethrough. Permeated water FW that has been desalinated is collected from the secondary surface constituting an inner circumference of the hollow-fiber-shaped RO membranes 2 to opposite end portions of each hollow-fiber-shaped RO membrane 2, and is collected from a permeated water outlet piping 4. Concentrated water that has not permeated into each of the hollow-fiber-shaped RO membranes 2 is discharged from a brine outlet piping 5 to the outside of the vessel 6.

After the seawater desalination treatment, metal scale including metal ions contained in seawater or organic scale including organic matter is adhered at least to the primary surface of the RO membrane 2. Not only to the primary surface, but also the same scale may adhere to the inside and the secondary surface of the RO membrane 2 in some cases. Generally, an amount of scale adhered to the primary surface is greater than that of scale adhered to the inside and the secondary surface of the RO membrane 2.

Hereinafter, an embodiment of the cleaning method of the present invention will be described using an example in which the RO membrane 2 provided in the RO membrane module 1 of FIG. 1 is cleaned.

Conventionally, a cleaning liquid having a temperature substantially the same as a seawater temperature of 15° C. to 25° C. has been used.

On the other hand, in the first embodiment of the reverse osmosis membrane cleaning method of the present invention, the RO membrane 2 is cleaned using cleaning water at a temperature higher than 45° C. and not higher than 60° C.

Since the cleaning water of the present embodiment is higher in temperature than that in conventional cases, detergency by stripping and eluting scale from the RO membrane 2 is high. By bringing this high temperature cleaning water into contact with the RO membrane 2, a more excellent cleaning effect than that in conventional cases can be obtained.

In conventional cleaning liquids, an oxidizing agent such as hypochlorous acid or hydrogen peroxide is generally contained for the purpose of enhancing detergency.

On the other hand, it is preferable that an oxidizing agent which easily generates radicals such as hypochlorous acid or hydrogen peroxide is not contained in the cleaning water of the present embodiment. This is because, when the cleaning water contains an oxidizing agent and is at a high temperature, oxidation degradation of the RO membrane 2 is remarkably promoted.

However, when the concentration is extremely low, an oxidizing agent such as hypochlorous acid or hydrogen peroxide may be contained in the cleaning water of the present embodiment. As a specific content concentration, for example, 0.001 to 1.0% by mass is preferable, and 0.01 to 0.1% by mass is more preferable. Here, the total mass of the cleaning water containing the oxidizing agent is referred to as 100% by mass.

As the oxidizing agent, hydrogen peroxide, percarbonates, persulfates, hypochlorites, permanganates, chlorine dioxide, and ozone are exemplified. Here, cations constituting each salt are not particularly limited, and inorganic cations such as sodium, potassium, lithium, calcium, magnesium, beryllium and ammonium are exemplified. More specifically, sodium percarbonate, sodium persulfate, ammonium persulfate, sodium hypochlorite, potassium permanganate can be exemplified as suitable salts as oxidizing agents. In the cleaning water, one or more kinds of oxidizing agents selected from a group which includes the plurality of oxidizing agents exemplified here may be contained.

In the present embodiment, since fresh water or seawater heated to a temperature higher than 45° C. and not higher than 60° C. is used for the cleaning water, it is possible to obtain sufficient detergency while suppressing degradation of the RO membrane 2. From the perspective of saving energy required for heating and from the perspective of preventing a change in physical properties of the RO membrane, the temperature of the cleaning water is preferably higher than 45° C. and not higher than 55° C., more preferably 48° C. or higher and 55° C. or lower, and still more preferably 50° C. or higher and 54° C. or lower.

The higher the temperature of the cleaning water in a range higher than 45° C. the more sufficient detergency can be obtained without using an oxidizing agent. On the other hand, when the cleaning water is in a range of 60° C. or lower, degradation of the RO membrane 2 can be suppressed to a level acceptable for practical use.

While a cleaning effect can be enhanced as the time for bringing the RO membrane 2 into contact with the cleaning water heated to a temperature higher than 45° C. and not higher than 60° C. becomes longer, that is, as the cleaning time becomes longer, the more the membrane degradation tends to progress. Therefore, the cleaning time is preferably 2 to 12 hours, more preferably 4 to 10 hours, and still more preferably 4 to 8 hours.

While a cleaning effect can be enhanced as the pH of the cleaning water heated to a temperature higher than 45° C. and not higher than 60° C. is increased, the more the membrane degradation tends to progress. Therefore, the pH of the cleaning water is preferably from pH 3.5 to 5.5, more preferably pH 4.0 to 5.5, and still more preferably pH 4.0 to 5.0.

A method for adjusting the pH is not particularly limited, and a method of adding an inorganic acid such as hydrochloric acid or sulfuric acid, or an aqueous alkaline solution such as sodium hydroxide or magnesium hydroxide is an example.

An organic acid may be contained in the cleaning water heated to a temperature higher than 45° C. and not higher than 60° C. An organic acid is less likely to cause membrane degradation compared to the above-described oxidizing agents and can enhance the cleaning effect.

As suitable organic acids, citric acid, phosphonic acid, glycolic acid (hydroxy acid), ethylenediamine tetraacetic acid (EDTA), formic acid, and oxalic acid are exemplified. Cleaning water of the present embodiment may contain one or more kinds of organic acids selected from a group which includes the plurality of organic acids exemplified here. The organic acid may be contained as organic acid salts having counter cations such as ammonium, sodium, calcium, magnesium and the like. Further, cleaning water containing an organic acid or organic acid salts can also be referred to as a cleaning liquid.

As one of mechanisms by which scale adhered to the RO membrane 2 is eluted, it is conceivable that metal ions contained in the scale and the organic acid are chelated and thereby dissolved in the cleaning water.

A concentration of the organic acid contained in the cleaning water of the present embodiment is not particularly limited and can be appropriately set depending on types of organic acids to be used within a range in which membrane degradation can be more sufficiently suppressed. A suitable concentration range of the organic acids exemplified above is, for example, preferably 0.001 to 5.0% by mass (0.01 to 50 g/L), more preferably 0.01 to 3.0% by mass (0.1 to 30 g/L), and still more preferably 0.02 to 2.0% by mass (0.2 to 20 g/L). Here, the total mass of the cleaning water containing the organic acid is referred to as 100% by mass.

When it is not less than the lower limit value of the above-described range, a cleaning effect by the organic acid can be sufficiently obtained.

When it is not higher than the upper limit value of the above-described range, membrane degradation by the organic acid can be sufficiently suppressed.

In order to enhance the cleaning effect and from a perspective of sufficiently suppressing the membrane degradation, the organic acid contained in the cleaning water of the present embodiment is preferably citric acid. The citric acid may be contained in the form of a citrate which is capable of being paired with a counter cation. The counter cation is not particularly limited, and cations such as ammonium, sodium, potassium, and magnesium are exemplified.

As an example, by adding ammonia dropwise after adding a predetermined amount of citric acid to cleaning water, it is possible to obtain cleaning water containing citric acid and ammonium citrate adjusted, for example, to pH 3.0 to 5.5.

When at least one of citric acid and a citrate is contained in the cleaning water of the present embodiment, it is preferable to be contained in a range of 2.0 to 22 g/L as a concentration of the citric acid.

A content of citric acid and a citrate per IL of the cleaning water containing citric acid is, preferably 3.0 to 22 g, more preferably 5.0 to 20 g, and still more preferably 7.0 to 15 g in terms of the mass of citric acid. When this range is converted to percentage on a mass basis, with respect to 100% of the cleaning water, the citric acid content is preferably 0.3 to 2.2%, more preferably 0.5 to 2.0%, and still more preferably 0.7 to 1.5%.

When it is not less than the lower limit value of the above-described range, a cleaning effect by citric acid can be more sufficiently obtained.

When it is not higher than the upper limit value of the above-described range, membrane degradation by citric acid can be more sufficiently suppressed.

The cleaning water adjusted as described above is brought into contact with at least the primary surface of the RO membrane 2 to remove scale adhered to the RO membrane 2. It is preferable that the cleaning water also comes into contact with the inside and the secondary surface of the RO membrane 2.

### <Cleaning Procedure>

### (Cleaning Process)

As a procedure of the cleaning method of the present embodiment, first, concentrated water is discharged from the brine outlet piping 5, cleaning water is injected into the vessel 6 from the supply piping 3, and at least the primary surface is maintained in a state of being immersed in the cleaning water. By allowing the cleaning water to permeate in a forward direction, with respect to the primary surface having a large amount of scale deposit, fresh cleaning water not containing any eluate from scale can be supplied. Further, when cleaning water is injected into the vessel 6, the cleaning water may be permeated in the forward direction (in a filtration direction) from the primary surface to the secondary surface of the RO membrane 2.

Instead of the above-described cleaning in the forward direction, reverse cleaning in which cleaning water is injected into the vessel 6 from the permeated water outlet piping 4 and the cleaning water is permeated in a reverse direction from the secondary surface to the primary surface of the RO membrane 2 may be performed, but an organic acid is consumed on the secondary surface side or trapped on the secondary surface without being able to permeate through the RO membrane 2, and thereby a sufficient amount of the organic acid is not supplied to the primary surface and there is possibility of a decrease in cleaning efficiency as compared with the case of the forward direction. When cleaning water is allowed to permeate in the reverse direction, an organic acid that can permeate through the RO membrane 2 is used or cleaning water not containing an organic acid is used.

After permeating cleaning water, by maintaining a state in which the cleaning water is filled in a space on a primary surface side of the RO membrane 2 in the vessel 6, at least the primary surface can be maintained in a state of being immersed in the cleaning water. In this state, by pressurizing slightly, some of the cleaning water permeates the inside of the RO membrane 2 and begins to permeate the secondary surface. With this pressurization, the inside and the secondary surface of the RO membrane 2 may also be immersed simultaneously with the primary surface.

Alternatively, cleaning water may be injected into the vessel 6 from the permeated water outlet piping 4 to fill an intra-membrane space on a water collecting side so that the secondary surface of the RO membrane 2 is maintained in a state of being immersed in the cleaning water.

A method of maintaining the RO membrane 2 in a state of being immersed in cleaning water is not particularly limited, and, for example, cleaning water may be supplied from the supply piping 3 to fill a space on the primary surface side of the RO membrane 2 in the vessel 6, and then the supply of the cleaning water may be stopped and the vessel 6 may be sealed so that circulation of the cleaning water is stopped.

Alternatively, even after filling the space on the primary surface side of the RO membrane 2 in the vessel 6 with cleaning water, by continuing to supply cleaning water and discharging the same amount of the cleaning water as the supply amount from the brine outlet piping 5, the state of the RO membrane 2 being immersed in cleaning water may be maintained while circulating the cleaning water.

In the cleaning method of the present embodiment, the cleaning while circulating cleaning water is preferable because the cleaning effect is enhanced. Further, as will be described below, by heating cleaning water while circulating, a temperature of the cleaning water is easily maintained at a predetermined temperature, which is preferable because a cleaning effect can be stably obtained.

By maintaining a state in which at least one, preferably both, of the primary surface and the secondary surface of the RO membrane 2 is immersed (exposed) in circulating cleaning water, scale adhered to the primary surface and the secondary surface is sufficiently eluted and the removal efficiency can be further enhanced.

It is preferable that the time of maintaining the state of being immersed is within the range of the above-described cleaning time.

In addition, a standard time for ending the cleaning may be set by measuring turbidity, a concentration of eluted scale, total organic carbon (TOC), chemical oxygen demand (COD), and the like of drainage of the cleaning water discharged after the cleaning by a known method.

The eluted scale is discharged together with the cleaning water to the outside of the vessel 6. A discharge port for discharging the cleaning water is not particularly limited, and it is preferable that it be discharged from the brine outlet piping 5 or the supply piping 3 from the perspective of preventing fouling of the RO membrane 2.

When scale remaining after a first cleaning is at a degree that cannot be accepted, the above-described cleaning procedure may be repeatedly performed two or more times to reach an acceptable degree.

A known agent such as a surfactant, a pH regulator, or the like that promotes cleaning may be added to the cleaning water described above as necessary.

### (Rinsing Process)

When cleaning water contains agents such as organic acids, in order to prevent these agents from remaining in the RO membrane after being cleaned, it is preferable to perform a rinsing process of rinsing the RO membrane 2 with a rinsing liquid such as seawater, fresh water, or the like which does not contain agents, after the cleaning process.

A method of rinsing the RO membrane 2 is not particularly limited, and a method in which seawater supplied from the supply piping 3 is brought into contact with the primary surface of the RO membrane 2 to maintain the RO membrane 2 in a state of being immersed in the seawater and is continuously discharged from the brine outlet piping 5, a method in which fresh water is injected in a reverse direction from the permeated water outlet piping 4 to perform flushing (reverse cleaning) of the RO membrane 2, and the like are examples.

By measuring an amount of the agents contained in a discharged rinsing liquid by a known method, it is possible to determine whether or not the rinsing process is ended. After completing the rinsing process, normal operation can be started.

### <Heating and Circulation of Cleaning Water>

In the present embodiment, cleaning water is preheated to a predetermined temperature and then the cleaning water is injected into the vessel 6. A method of supplying heated cleaning water is not particularly limited, and a method in which cleaning water is heated by a heat exchanger connected to a boiler and then supplied into the vessel 6 and a method in which cleaning water is heated by an electric heater and then supplied into the vessel 6 are examples.

It is preferable to circulate the cleaning water discharged after circulating in the vessel 6 and cleaning the RO membrane 2 through the reverse osmosis membrane while passing it through a filter.

Since dust and scale dissolved in the cleaning water that has cleaned the RO membrane 2 can be removed by the filter, the cleaning water can be reused and the cost required for a process of disposing the cleaning water can be reduced.

The cleaning water discharged after circulating in the vessel 6 and cleaning the RO membrane 2 is still in a warm state. Since the discharged cleaning water is collected and filtered by a separate filter to remove the scale eluted in the cleaning water, the cleaning water in a warm state can be regenerated and supplied to the RO membrane 2 in the vessel 6 again for the purpose of cleaning.

Therefore, in the present embodiment, it is preferable to heat cleaning water while circulating it as described above. Since cleaning water is heated while being circulated, it is possible to reduce the cost required for heating. In addition, it is possible to reduce the cost required for preparation of cleaning water and the cost required for a process of disposing the cleaning water. Further, since cleaning water at a predetermined temperature can be stably supplied into the vessel 6, a stable cleaning effect can be obtained.

A method of heating cleaning water while circulating is not particularly limited, and a method of using a reverse osmosis membrane cleaning apparatus 10 exemplified in FIG. 2 is an example. A configuration of the reverse osmosis membrane cleaning apparatus 10 will be described below.

### <Reverse Osmosis Membrane Cleaning Apparatus 10>

As illustrated in FIG. 2, the reverse osmosis membrane cleaning apparatus 10 of the present embodiment includes the RO membrane module 1, a cleaning water tank 11, a circulation pump 12, a heat exchanger (heater) 13, a regulating valve 14, a temperature sensor 15, a filter 16, and a control device 17.

The cleaning water tank 11 is provided between the discharge port of the RO membrane module 1 and the circulation pump 12, and temporarily stores cleaning water circulating through a flow path of the reverse osmosis membrane cleaning apparatus 10.

The circulation pump 12 is provided between the cleaning water tank 11, and the heat exchanger 13 and the regulating valve 14, supplies the cleaning water stored in the cleaning water tank 11 to the filter 16 and the RO membrane module 1 via the heat exchanger 13 or the regulating valve 14, and sends cleaning water discharged from the RO membrane module 1 to the cleaning water tank 11.

Further, operation and stopping of a pump drive in the circulation pump 12 may be controlled by a pump control device (not illustrated). Under the control of the pump control device, by stopping the circulation pump 12 after operation for a predetermined time (for example, 12 hours or less) to end the cleaning treatment, it is possible to prevent the reverse osmosis membrane from degrading due to inadvertent prolonged cleaning.

The heat exchanger 13, as an example of a heater, is provided between the circulation pump 12 and the filter 16, and performs heat exchange between the cleaning water and separately prepared high temperature water via physical heat conduction to heat (heating) the cleaning water.

Further, a heater is not limited to a heat exchanger, and various devices capable of heating the cleaning water may be employed.

The regulating valve 14 is provided between the circulation pump 12 and the filter 16. The regulating valve 14 regulates a distribution ratio between a flow rate A of the cleaning water supplied to the filter 16 and the RO membrane module 1 after being heated by passing through the heat exchanger 13 and a flow rate B of the cleaning water supplied to the filter 16 and the RO membrane module 1 bypassing the heat exchanger 13. Specifically, when a valve opening degree of the regulating valve 14 is controlled to decrease, the flow rate A increases and the flow rate B relatively decreases. On the other hand, when the valve opening degree of the regulating valve 14 is controlled to increase, the flow rate A decreases and the flow rate B relatively increases.

The temperature sensor 15 detects a temperature of the cleaning water obtained by mixing the cleaning water that has passed through the heat exchanger 13 and the cleaning water that bypassed the heat exchanger 13 before being supplied to the filter 16 and the RO membrane module 1, or before being supplied to the RO membrane module 1. The temperature sensor 15 inputs the detected temperature to a controller 18.

The filter 16 is provided between the heat exchanger 13 and the regulating valve 14, and the RO membrane module 1, and removes dust and scale contained in the cleaning water just before being supplied to the RO membrane module 1 by filtration.

The control device 17 includes the controller 18. The controller 18 performs the following control by processing of the control device 17.

The controller 18 controls each functional unit of the reverse osmosis membrane cleaning apparatus 10 so that a temperature of the cleaning water supplied to the RO membrane module 1 becomes a desired temperature. For example, the controller 18 regulates a temperature of the circulating cleaning water by controlling the valve opening degree of the regulating valve 14 to adjust a distribution ratio between the flow rate A and the flow rate B. Specifically, when a temperature of the cleaning water detected by the temperature sensor 15 is lower than a desired temperature, the controller 18 performs control to increase a proportion of the flow rate A of the cleaning water heated by passing through the heat exchanger 13. Also, when a temperature of the cleaning water detected by the temperature sensor 15 is higher than a desired temperature, the controller 18 performs control to increase a proportion of the flow rate B of the cleaning water bypassing the heat exchanger 13.

When the proportion of the flow rate A increases, an amount of heat supplied to the circulating cleaning water from the heat exchanger 13 increases, and thus the temperature of the circulating cleaning water gradually increases.

When the proportion of the flow rate 13 increases, since heat is spontaneously dissipated from the cleaning water during circulation, the temperature of the circulating cleaning water naturally decreases gradually.

The change in temperature of the circulating cleaning water is detected by the temperature sensor 15 and is input to the controller 18.

While controlling as described above, cleaning water in the cleaning water tank 11 is supplied to the filter 16 and the RO membrane module 1 by the circulation pump 12 via a first flow path having the heat exchanger 13 or a second flow path having the regulating valve 14, and cleaning water which has cleaned the RO membrane 2 included in the RO membrane module 1 is collected in the cleaning water tank 11. As a result, it is possible to circulate the reused cleaning water while heating.

A hot water generating device 19, a hot water pump 20, and a three-way valve 21 may be provided in the reverse osmosis membrane cleaning apparatus 10 as arbitrary configurations.

The hot water generating device 19 is a heat source device which generates high temperature water to be supplied to the heat exchanger 13, and a boiler or an electric heater is an example. An arrow G of FIG. 2 represents a gas exhausted from the boiler.

The hot water pump 20 is provided between the heat exchanger 13 and the hot water generating device 19, and sends high temperature water generated by the hot water generating device 19 to the three-way valve 21.

The three-way valve 21 having three valves is provided among the hot water generating device 19, the heat exchanger 13, and the hot water pump 20. One of the three valves is connected to the heat exchanger 13. Another one of the three valves is connected to the hot water generating device 19. Another one of the three valves is connected to the hot water pump 20.

In the reverse osmosis membrane cleaning apparatus 10, the controller 18 may control at least one functional unit among the hot water generating device 19, the hot water pump 20, and the three-way valve 21 so that a temperature of the cleaning water supplied to the RO membrane module 1 becomes a desired temperature. For example, the controller 18 controls opening and closing of each valve of the three-way valve 21, and increases a flow rate of high temperature water supplied to the heat exchanger 13 when the heat exchanger 13 requires a lot of heat. On the other hand, when the heat exchanger 13 does not require a lot of heat, the flow rate of the high temperature water bypassing the heat exchanger 13 to be directly sent to the hot water pump 20 is increased. Specifically, when a temperature of the cleaning water detected by the temperature sensor 15 is lower than a desired temperature, the controller 18 performs control to increase a flow rate of the high temperature water sent to the heat exchanger 13. Also, when a temperature of the cleaning water detected by the temperature sensor 15 is higher than a desired temperature, the controller 18 performs control to increase a flow rate of the high temperature water bypassing the heat exchanger 13 to be sent to the hot water pump 20. With the control as above, an amount of heat supplied to the heat exchanger 13 is adjusted, an amount of heat supplied to cleaning water from the heat exchanger 13 is adjusted, and thereby the temperature of the circulating cleaning water is adjusted.

Further, the controller 18 may control the operation and stopping of the hot water generating device 19 and the hot water pump 20 as necessary.

While an embodiment of the reverse osmosis membrane cleaning method according to the present invention has been described, the present invention is not limited to the above-described embodiment and can be modified appropriately without departing from the scope of the present invention, and the components in the above-described embodiment can be appropriately replaced with well-known components.

### EXAMPLES

Next, the present invention will be described in more detail using examples, but the present invention is not limited by these examples.

An RO membrane made of cellulose triacetate which had been used in a seawater desalination treatment plant and had an operation history of 35,000 hours or more was installed in the RO membrane module 1 illustrated in FIG. 1 for testing and was cleaned as follows.

Regarding each RO membrane 2 used in each example, a water permeability coefficient (A-value) and a salt permeability coefficient (B-value) were measured before and after the cleaning by a conventional method.

A higher rate of increase in water permeability coefficient indicates a higher cleaning effect. On the other hand, a higher rate of increase in salt permeability coefficient indicates that more degradation of the RO membrane 2 has progressed.

The water permeability coefficient (A-value) is also called an A value, which is a coefficient representing liquid permeation performance in RO membranes or nanofiltration (NF) membranes, and is generally expressed by a relational expression of solution (volume) permeation flow velocity Jv=A value×(inter-membrane differential pressure ΔP−osmotic pressure difference Δπ).

The salt permeability coefficient (B-value) is also called a B value, which is a coefficient representing solute permeability in RO membranes or NF membranes, and is generally expressed by a relational expression of solute permeation flow velocity Js=B value×(solute concentration Cm of membrane surface−solute concentration Cp of permeated water).

### Example 1

Hot water of 45° C., 48° C., 50° C., and 54° C. was used as cleaning water to clean the primary surface of the RO membrane 2. At this time, circulation cleaning was performed for 4 hours with the cleaning water maintained at a predetermined temperature by continuously supplying the cleaning water from the supply piping 3 into the vessel 6 and continuously discharging a discharged liquid after cleaning the RO membrane 2 from the brine outlet piping 5. The pH of the cleaning water was about 6. The reason for being weakly acidic, pH6, is considered to be due to contact with air during the circulation and carbon dioxide in the air is dissolved in the cleaning water.

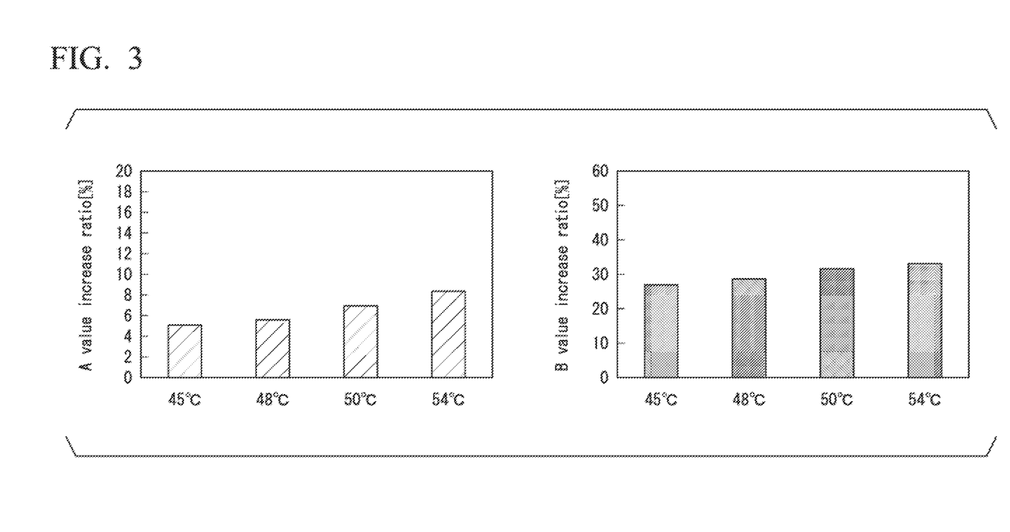

As illustrated in FIG. 3, as a result of the circulation cleaning with the cleaning water, it was found that, as the temperature of the cleaning water became higher, the rate of increase in the water permeability coefficient (A-value) improved and the cleaning effect improved. On the other hand, it was found that, as the temperature of the cleaning water became higher, the rate of increase in the salt permeability coefficient (B-value) also increased and degradation of the RO membrane progressed. In other words, it was found that there was a trade-off relationship between suppressing degradation of the RO membrane and enhancing the cleaning effect.

From the results described above, in consideration of the trade-off relationship, it can be said that a temperature of the cleaning water is preferably higher than 45° C. and not higher than 60° C., more preferably 48° C. or higher and 55° C. or lower, and still more preferably 50° C. or higher and 54° C. or lower.

### Example 2

The RO membrane 2 was cleaned in the same manner as in Example 1 except that the time of the circulation cleaning with the cleaning water set at 54° C. was increased from 4 hours (Example 1) to 8 hours (Example 2).

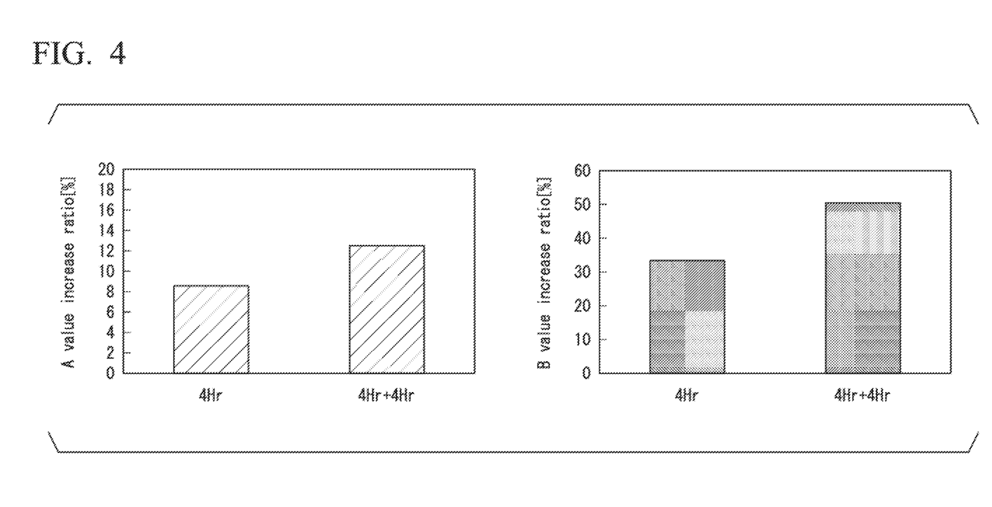

As a result, as illustrated in FIG. 4, it was found that, as the cleaning time became longer, the rate of increase in the water permeability coefficient (A-value) improved and the cleaning effect improved. On the other hand, it was found that, as the cleaning time became longer, the rate of increase in the salt permeability coefficient (B-value) also increased and degradation of the RO membrane progressed. In other words, it was found that there was the trade-off relationship between suppressing degradation of the RO membrane and enhancing the cleaning effect.

From the results described above, in consideration of the trade-off relationship, it can be said that the time for cleaning with the cleaning water is preferably 2 to 12 hours, more preferably 4 to 10 hours, and still more preferably 4 to 8 hours.

### Example 3

Circulation cleaning was performed for 8 hours in the same manner as in Example 2 using cleaning water at 54° C. and adjusted to pH 6, pH 5, and pH4.

The pH 6 cleaning water was the same 54° C. hot water as in Example 1. The pH 5 cleaning water was prepared by adding hydrochloric acid dropwise into hot water. The pH 4 cleaning water was prepared by adding ammonia dropwise into hot water containing 0.2 g/L (0.02% by mass) of citric acid.

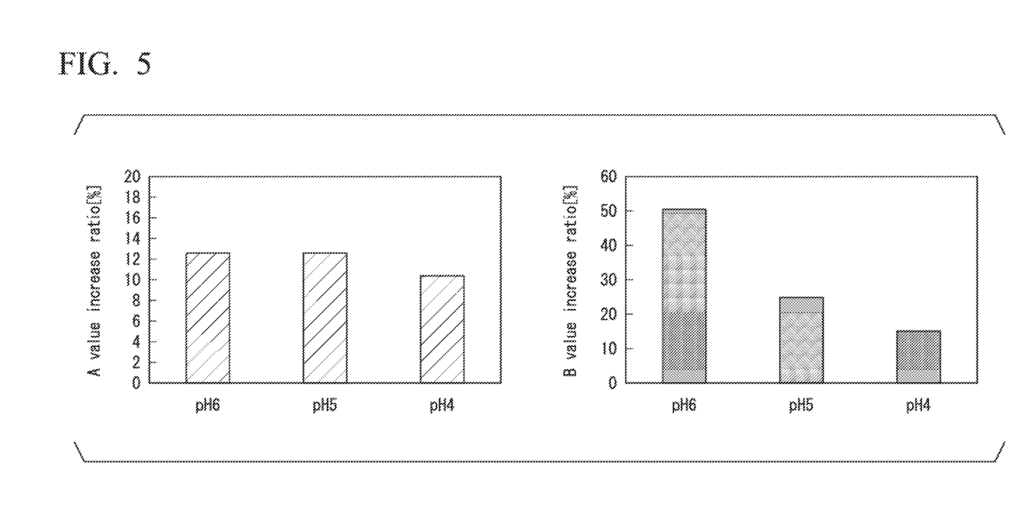

As a result, as illustrated in FIG. 5, pH5 and pH 6 exhibited similar results while pH 4 exhibited a relatively low rate of increase in the water permeability coefficient (A-value). On the other hand, it was found that, as the pH became lower, the rate of increase in the salt permeability coefficient (B-value) decreased and degradation of the RO membrane could be suppressed. Also in the present example, it was found that there was the trade-off relationship between suppressing degradation of the RO membrane and enhancing the cleaning effect.

From the results described above, in consideration of the trade-off relationship, when a temperature of the cleaning water is higher than 45° C. and not higher than 60° C., it can be said that the pH of the cleaning water is preferably pH 3.5 to 5.5, more preferably pH 4.0 to 5.5, and still more preferably pH 4.0 to 5.0.

### Example 4

Circulation cleaning was performed for 8 hours in the same manner as in Example 2 using cleaning water containing citric acid at a concentration of 0.02, 0.2, 0.5, 1.0, and 2.0 (units: % (mass basis)) at 54° C. and adjusted to pH 4 by adding ammonia dropwise. Here, the mass of the citric acid contained in the cleaning water was respectively 0.2 g, 2.0 g, 5.0 g, 10 g, and 20 g per 1 L. of the cleaning water.

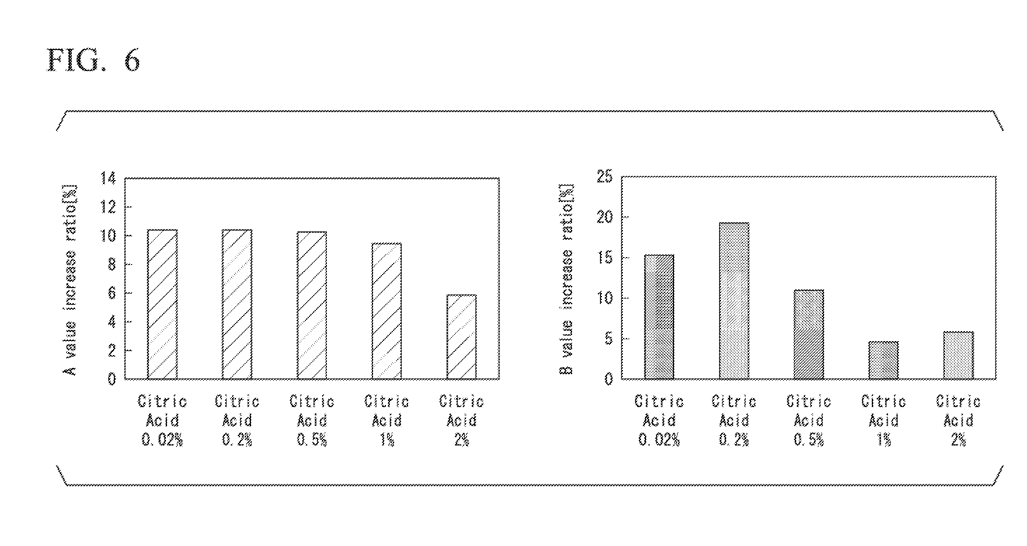

As a result, as illustrated in FIG. 6, 0.02 to 0.5% exhibited similar results while 1.0% exhibited a lower rate of increase, and 2.0% exhibited an even lower rate of increase in the water permeability coefficient (A-value). On the other hand, it was found that the rate of increase in the salt permeability coefficient (B-value) decreased and degradation of the RO membrane could be suppressed at a citric acid concentration of 0.5% or more. Also in this example, it was found that there was a general trade-off relationship between suppressing degradation of the RO membrane and enhancing the cleaning effect, but it was found that, particularly in the case of a citric acid concentration of 1.0%, degradation of membrane could be further suppressed while maintaining the cleaning effect.

From the results described above, when a temperature of the cleaning water is higher than 45° C. and not higher than 60° C. and the pH is from 3.5 to 5.5, it can be said that the citric acid concentration is preferably 0.3 to 2.2%, more preferably 0.5 to 2.0%, and still more preferably 0.7 to 1.5% on a mass basis. That is, it can be said that the mass of citric acid and a citrate contained in cleaning water per IL is preferably 3.0 to 22 g. more preferably 5.0 to 20 g, and still more preferably 7.0 to 15 g in terms of the mass of citric acid.

### Example 5

Circulation cleaning was performed for 3 hours in the same manner as in Example 2 using cleaning water at each temperature of 50° C., 54° C., and 60° C. containing citric acid at a concentration of 2.0 (units: % (mass basis)) and adjusted to pH 4 by adding ammonia dropwise.

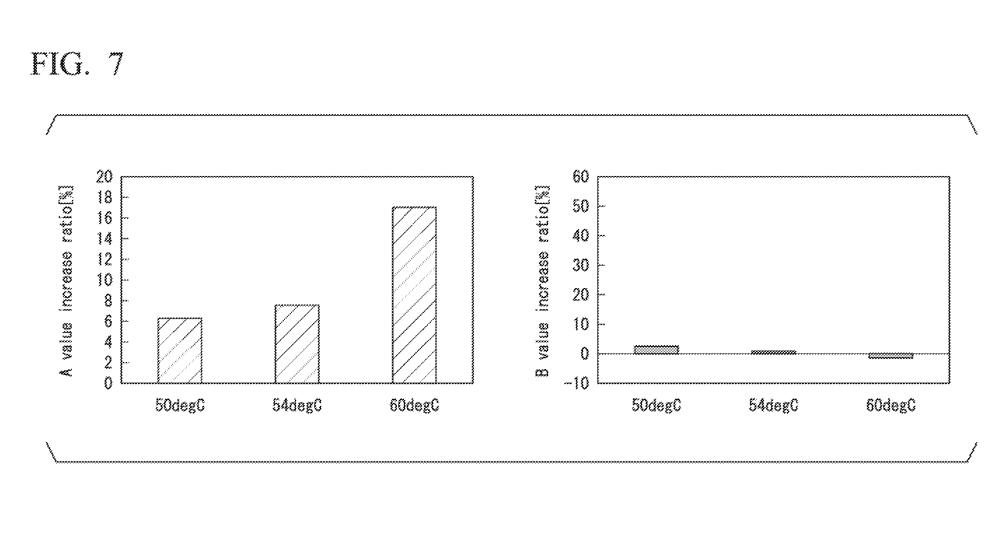

As a result, as illustrated in FIG. 7, in the order of 50° C., 54° C. and 60° C., the rate of increase in the water permeability coefficient (A-value) increased and an effect of increasing the salt permeability coefficient (B-value) was also slight.

While embodiments of the present invention have been described above in detail with reference to the accompanying drawings, the respective configurations and combinations thereof in the respective embodiments are merely examples, and additions, omissions, substitutions, and other changes to the configurations are possible without departing from the scope of the present invention. In addition, the present invention is not limited by the embodiments described above, and is limited only by the claims.

### REFERENCE SIGNS LIST

1 RO membrane module
2 RO membrane
3 Supply piping
4 Permeated water outlet piping
5 Brine outlet piping
6 Vessel
10 Reverse osmosis membrane cleaning apparatus
11 Cleaning water tank
12 Circulation pump
13 Heat exchanger (heater)
14 Regulating valve
15 Temperature sensor
16 Filter
17 Control device
18 Controller
19 Hot water generating device
20 Hot water pump
21 Three-way valve

1. A reverse osmosis membrane cleaning method, comprising:
cleaning a reverse osmosis membrane with a cleaning water having a temperature higher than 45° C. and not higher than 60° C.

2. The reverse osmosis membrane cleaning method according to claim 1, wherein the cleaning water is circulated through the reverse osmosis membrane while passing through a filter.

3. The reverse osmosis membrane cleaning method according to claim 1, wherein an organic acid is contained in the cleaning water.

4. The reverse osmosis membrane cleaning method according to claim 3, wherein citric acid and a citrate as the organic acid are contained in a range of 2.0 to 22 g/L as a citric acid concentration.

5. The reverse osmosis membrane cleaning method according t claim 1, wherein the pH of the cleaning water is adjusted to a range of 3.5 to 5.5.

6. The reverse osmosis membrane cleaning method according to claim 1, wherein a cleaning time in which the cleaning water and the reverse osmosis membrane are in contact is 12 hours or less.

7. The reverse osmosis membrane cleaning method according to claim 1, wherein the reverse osmosis membrane is formed of a cellulose-based polymer or a polyamide-based polymer.

8. A reverse osmosis membrane cleaning apparatus comprising:
a membrane module which includes a reverse osmosis membrane;
a cleaning water tank which stores cleaning water;
a heater which heats cleaning water supplied from the cleaning water tank to the reverse osmosis membrane; and
a temperature control device which controls the heater so that a temperature of the cleaning water heated by the heater is higher than 45° C. and not higher than 60° C.

9. The reverse osmosis membrane cleaning apparatus according to claim 8, wherein the temperature control device controls the heater so that a temperature of the cleaning water heated by the heater is higher than 45° C. and not higher than 55° C.

10. The reverse osmosis membrane cleaning apparatus according to claim 8, further comprising:
a circulation pump which circulates the cleaning water between the membrane module and the cleaning water tank; and
a filter through which the circulating cleaning water passes.

11. The reverse osmosis membrane cleaning apparatus according to claim 8, wherein an organic acid is contained in the cleaning water.

12. The reverse osmosis membrane cleaning apparatus according to claim 11, wherein citric acid and a citrate as the organic acid are contained in a range of 2.0 to 22 g/L as a citric acid concentration.

13. The reverse osmosis membrane cleaning apparatus according to claim 8, wherein the pH of the cleaning water is in a range of 3.5 to 5.5.

14. The reverse osmosis membrane cleaning apparatus according to claim 8, further comprising:
a pump control device which controls to stop driving of the circulation pump within 12 hours or less after driving the circulation pump.

15. The reverse osmosis membrane cleaning apparatus according to claim 8, wherein the reverse osmosis membrane is formed of a cellulose-based polymer or a polyamide-based polymer.
